(19) United States
(12) Patent Application Publication
(10) Pub. No.: US 2025/0266727 A1
(43) Pub. Date: Aug. 21, 2025

(54) STATOR

(71) Applicant: TOYOTA JIDOSHA KABUSHIKI KAISHA, Toyota-shi (JP)

(72) Inventors: Kengo OHIRA, Toyota-shi (JP); Akihide Takehara, Toyota-shi (JP); Noriyoshi Yamada, Nagoya-shi (JP); Yuki Mori, Toyota-shi (JP)

(73) Assignee: TOYOTA JIDOSHA KABUSHIKI KAISHA, Toyota-shi (JP)

(21) Appl. No.: 18/944,438

(22) Filed: Nov. 12, 2024

(30) Foreign Application Priority Data
Feb. 20, 2024 (JP) 2024-024075

(51) Int. Cl. H02K 3/28

(52) U.S. Cl. CPC H02K 3/28

(57) ABSTRACT

The stator includes a stator core, slots, and coils. The number n of slots satisfies n=6 p when the number of magnetic poles of a rotor is P. In each slot, coil segments are arranged to form layers along the radial direction. In each coil, a start point and an end point are provided on the first end surface side of the stator core. In the outermost layer and the innermost layer in the radial direction in the slot, two coil segments located in the same layer are connected to each other. The section that is displaced in the radial direction between the outermost layer and the innermost layer has an oblique wave winding section in which a direction displaced in the circumferential direction and the radial direction on the first end surface side and that on the second end surface side are continuously coincident with each other.

### CROSS-REFERENCE TO RELATED APPLICATION

This application claims priority to Japanese Patent Application No. 2024-024075 filed on Feb. 20, 2024, incorporated herein by reference in its entirety.

### BACKGROUND

### 1. Technical Field

The technology disclosed by the present specification relates to a stator of an electric motor.

### 2. Description of Related Art

Japanese Unexamined Patent Application Publication No. 2020-103038 (JP 2020-103038 A) describes a stator of an electric motor. The stator includes a stator core, a plurality of slots provided in the stator core, and a plurality of stator coils (also simply called coils) constituted by the coil segments. The coils are wound in a distributed manner along an irregular slot pitch (interval) on the slots.

### SUMMARY

In the stator of the electric motor, it is necessary to suppress the generation of resonance of the coil. This is because, for example, when resonance of the coil occurs, there is a risk that an excessive surge voltage is generated. Resonance of the coil depends not only on an electrical characteristic (natural frequency) of the coil, but also on an electrical characteristic (natural frequency) of an inverter connected to the coil. Namely, even in a stator in which resonance does not manifest in combination with a certain inverter, resonance that cannot be ignored may occur in combination with another inverter. Therefore, for example, when a design change of the inverter is performed and the electrical characteristic of the inverter is changed, a design change of the stator (namely, an adjustment of the electrical characteristic of the coil) is often necessary in accordance with the design change of the inverter.

Changing a winding method of a coil with respect to a stator core is provided as an example of a technique that adjusts the electrical characteristic of the coil. Conventionally, two technique of “lap winding” and “wave winding” are known as winding methods of a coil. Also, the electrical characteristic of the coil is adjusted by changing from lap winding to wave winding, or performing an opposite change. However, even if a change is simply performed between these two winding methods, resonance of the coil may not be able to be sufficiently suppressed due to combined inverters.

In view of the circumstances, the present specification provides a novel and useful technology for a winding method of a coil in a stator.

The technology disclosed by the present specification is embodied in a stator of a motor that is driven by electrical power. The stator includes a cylindrical stator core extending in an axial direction between a first end surface and a second end surface, a plurality of slots provided on an inner peripheral surface of the stator core and arranged along a circumferential direction, each of the slots extending along the axial direction, and a plurality of coils wound in a distributed manner on the slots, each of the coils being constituted by a plurality of coil segments.

When the number of the slots is n and the number of magnetic poles of a rotor is P, a relationship of n=6 p is satisfied,
the coil segments are arranged in each of the slots so that a plurality of layers is constituted along a radial direction,
in each of the coils,
a start point and an end point are provided on the first end surface side of the stator core,
in an outermost layer and an innermost layer in the radial direction within the slot, two coil segments located in a same layer are connected to each other, and
a section that is displaced in the radial direction between the outermost layer and the innermost layer includes an oblique wave winding section in which a direction of displacement in the circumferential direction and the radial direction on the first end surface side and a direction of displacement in the circumferential direction and the radial direction on the second end surface side continuously coincide with each other.

In the configuration, each coil includes the oblique wave winding section. The winding method of the coil in the oblique wave winding section (hereinafter, called oblique wave winding) is different from either conventional lap winding or wave winding.

For example, in conventional lap winding, the coil is displaced in an opposite direction in relation to the circumferential direction, between the first end surface side and the second end surface side of the stator core. Namely, when the coil is displaced to one side in the circumferential direction on the first end surface side, the coil is displaced to the other side in the circumferential direction on the second end surface side. Therefore, in lap winding, the direction in which the coil is displaced in the circumferential direction on the first end surface side and the direction in which the coil is displaced in the circumferential direction on the second end surface side do not continuously coincide with each other. In contrast, in oblique wave winding relating to the present technology, the direction of displacement in the circumferential direction on the first end surface side and the direction of displacement in the circumferential direction on the second end surface side continuously coincide with each other, and is different from lap winding by this point.

On the other hand, in conventional wave winding, the coil is displaced in an opposite direction in relation to the radial direction, between the first end surface side and the second end surface side of the stator core. Namely, when the coil is displaced to an inner side in the radial direction on the first end surface side, the coil is displaced to an outer side in the radial direction on the second end surface side. Therefore, in wave winding, the direction in which the coil is displaced in the radial direction on the first end surface side and the direction in which the coil is displaced in the radial direction on the second end surface side do not continuously coincide with each other. On the other hand, in the stator relating to the present technology, the direction in which the coil is displaced in the radial direction on the first end surface side of the stator core and the direction in which the coil is displaced in the radial direction on the second end surface side of the stator core continuously coincide with each other, and is different from wave winding by this point.

As described, oblique wave winding relating to the present technology is different from conventional lap winding and wave winding, as a winding method of the coil. Therefore, as an objective of resonance suppression of the coil, when the winding method of the coil is changed, in addition to conventional lap winding and wave winding, oblique wave winding can be added as a new selection. As a result, a degree of freedom when adjusting the electrical characteristic of the stator increases, and it becomes possible to more effectively suppress resonance of the coil.

In one embodiment of the present technology, in each of the coils, the section that is displaced in the radial direction between the outermost layer and the innermost layer within the slot may further include an overlapping winding section in which a direction of displacement in the circumferential direction on the first end surface side and a direction of displacement in the circumferential direction on the second end surface side are mutually inverted.

In the configuration, in addition to the oblique wave winding section, each coil further includes the overlapping winding section. According to the configuration, a frequency band in which the coil resonates can be dispersed. Moreover, the electrical characteristic of the coil can be finely adjusted, by changing a ratio between the oblique wave winding section and the overlapping winding section.

In one embodiment of the present technology, in each of the coils, the section that is displaced in the radial direction between the outermost layer and the innermost layer may further include a wave winding section in which a direction of displacement in the circumferential direction on the first end surface side and a direction of displacement in the circumferential direction on the second end surface side continuously coincide with each other, and the overlapping winding section may be located between the oblique wave winding section and the wave winding section in the radial direction.

In the configuration, in addition to the oblique wave winding section and the overlapping winding section, each coil further includes the wave winding section. According to the configuration, a frequency band in which the coil resonates can be further dispersed. Moreover, the electrical characteristic of the coil can be finely adjusted, by changing a ratio between the oblique wave winding section, the wave winding section, and the overlapping winding section.

The coils of one embodiment of the present technology may be 2Y or 4Y type parallel wiring, and each start point of each coil of a same phase from among the coils may be located spaced apart by 12 q+1 (q being a natural number) slots.

According to the configuration, a potential difference between adjacent coils can be reduced, and a surge voltage can be further reduced.

In each of the coils in one embodiment of the present technology, the coil segment located on the innermost layer in the radial direction within the slot may be constituted by a litz wire.

According to the above configuration, an energy loss (for example, a copper vortex loss) in the coil can be reduced. In particular, in the stator relating to the present technology, the coil segment located on the innermost layer within the slot is connected to the coil segment similarly located on the innermost layer. Therefore, an energy loss in the coil can be effectively reduced, by adopting a litz wire in only the coil segment located on the innermost layer within the slot.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a stator 2 according to a first embodiment;

FIG. 2A shows the winding method of the first U-phase coil U1 in the first embodiment;

FIG. 2B shows the winding orientation of the second U-phase coil U2;

FIG. 3A shows the winding method of the first U-phase coil U1 in the second embodiment;

FIG. 3B shows the winding orientation of the second U-phase coil U2;

FIG. 4A shows the winding method of the first U-phase coil U1 in a modification of the second embodiment;

FIG. 4B shows the winding orientation of the second U-phase coil U2;

FIG. 5A shows the winding method of the first U-phase coil U1 in the third embodiment;

25 FIG. 5B shows the winding orientation of the second U-phase coil U2; and

FIG. 6 is a diagram schematically showing a joining method shown in paragraph 0053.

### DETAILED DESCRIPTION OF EMBODIMENTS

### First Embodiment

The stator 2 of the first embodiment will be described with reference to the drawings. The stator 2 of the present embodiment is one of the components of the electric motor. The stator 2 constitutes a power generation unit of an electric motor together with a rotor (not shown). Note that the configuration described in this embodiment is not limited to the three-phase AC motor, and can be similarly adopted to other types of electric motors. Further, the electric motor in which the stator 2 is used may be constituted by a Y-connection, or may be constituted by a delta-connection or an H-connection.

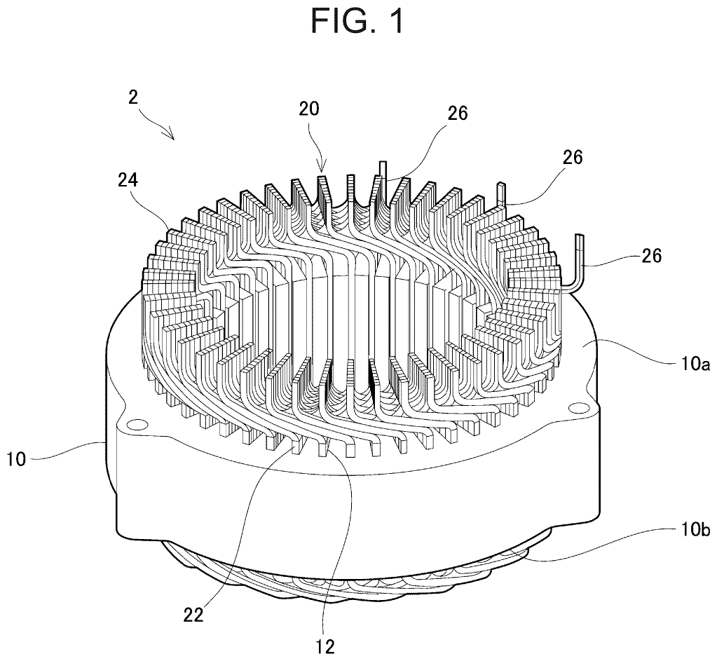

As shown in FIG. 1, the stator 2 of the first embodiment includes a stator core 10, a plurality of slots 12 provided in the stator core 10, and a plurality of coils 20. The stator core 10 is made of a soft magnetic material such as electromagnetic steel. The stator core 10 has a cylindrical shape and extends in an axial direction between the first end surface 10a and the second end surface 10b. A plurality of slots 12 are formed in the inner circumferential surface of the stator core 10. The plurality of slots 12 are arranged along the circumferential direction. Each of the plurality of slots 12 extends along the axial direction. The specific configuration of the stator core 10 is not particularly limited.

The plurality of coils 20 includes two U-phase coils, two V-phase coils, and two W-phase coils. The U-phase coil, the V-phase coil, and the W-phase coil have different positions in the circumferential direction in the stator core 10, but the other configurations are common to each other. Each coil 20 is wound in a so-called distributed manner with respect to a plurality of slots 12. Each coil 20 is composed of a plurality of coil segments 22. At the start end of each coil 20, a lead wire 26 is provided on the first end surface 10a of the stator core 10. When the plurality of coils 20 are formed by Y-connection, the ends of the coils 20 may be connected to each other on 10a of the first end surface of the stator core 10.

Each coil 20 is composed of a plurality of coil segments 22. Each of the coil segments 22 has a U-shape and is inserted into two slots 12 spaced apart from the second end surface 10b of the stator core 10 by a predetermined distance. The respective protrusions 24 of the respective coil segments 22 project from the first end surface 10a of the stator core 10. The protrusions 24 of the coil segments 22 protruding from the first end surface 10a are bent and joined to the protrusions 24 of the corresponding other coil segments 22. As a result, the plurality of coil segments 22 are connected in series, so that each coil 20 is configured. As another embodiment, the plurality of coil segments 22 may be fitted to each other inside the slot 12. Here, each of the coil segments 22 has an I-shaped shape (i.e., a linear shape) and may be bent on both end surfaces 10a, 10b of the stator core 10.

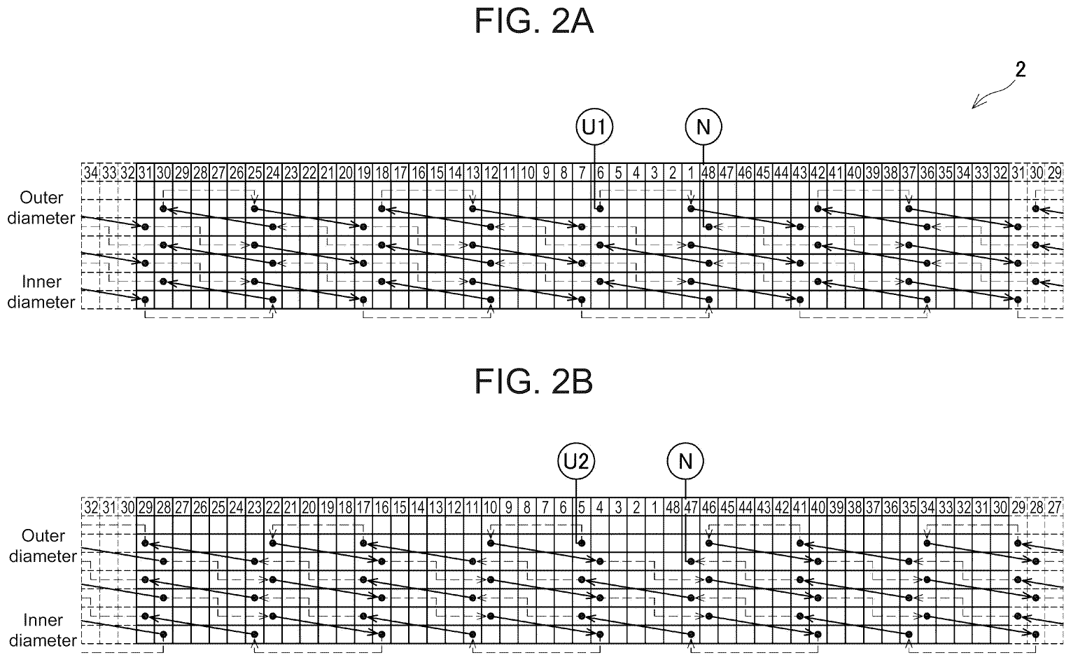

Referring to FIGS. 2A and 2B, the winding method of the plurality of coils 20 in the stator 2 of the first embodiment will be described. FIG. 2A shows the winding of the first U-phase coil of the plurality of coils 20, FIG. 2B shows the winding method of the second U-phase coil. In FIGS. 2A and 2B, the columns indicate the positions of the slots 12 in the stator core 10. The row indicates the position in the circumferential direction of the coil segment 22 in each slot 12. It should be noted that a row positioned above means that the coil segment 22 is positioned outward in the radial direction. As shown in FIGS. 2A and 2B, the inner peripheral surface of the stator core 10, 48 slots 12 are provided, in the respective slots 12, six layers of the coil segments 22 are housed.

In FIG. 2A, reference numeral U1 denotes the start point of the first U-phase coil, and reference numeral N denotes the end point of the first U-phase coil. The solid-line arrow in the figure shows a state in which the first U-phase coil is displaced on the first end surface 10a side of the stator core 10, and the broken-line arrow in the figure shows a state in which the first U-phase coil is displaced on the second end surface 10b side of the stator core 10. As shown in FIG. 2A, 1U phase coil extends from a start point the first layer (outermost layer) of the sixth slot toward the second end surface 10b from the first end surface 10a of the stator core 10 in the sixth slot. The first U-phase coil is displaced to the first layer of the first slot on the second end surface 10b of the stator core 10, and extends from the second end surface 10b of the stator core 10 toward the first end surface 10a in the first slot. Then, the first U-phase coil shifts to the second layer of the 43rd slot in the first end surface 10a side of the stator core 10, extends the 43rd slot from the first end surface 10a of the stator core 10 to the second end surface 10b.

Thereafter, the first U-phase coil is displaced in order to the third layer of the 37th slot, the fourth layer of the 31st slot, the fifth layer of the 25th slot, and the sixth layer (innermost layer) of the 19th slot. Then, the first U-phase coil is displaced to the twelfth slot in the same sixth layer, and then inverted to displace to the fifth layer of the eighteenth slot. Thereafter, the first U-phase coil is displaced in order to the fourth layer of the 24th slot, the third layer of the 30th slot, the second layer of the 36th slot, the first layer of the 42nd slot (outermost layer). Then, the first U-phase coil is inverted and displaced to the 37th slot in the same first layer, and then displaced to the second layer in the 31st slot. Hereinafter, the first U-phase coil reaches the end point located in the second phase of the forty-eighth slot by repeating the same displacement.

As described above, in the first U-phase coil, the start point (U1) and the end point (N) are provided on the first end surface 10a of the stator core 10. In the first layer (outermost layer) and the sixth layer (innermost layer) in the radial direction in the slot 12, two coil segments 22 located in the same layer are connected to each other. Further, a section that is displaced in the radial direction between the first layer and the sixth layer is an oblique wave winding section. In the oblique wave winding section, the direction displaced in the circumferential direction and the radial direction on the first end surface 10a side and the direction displaced in the circumferential direction and the radial direction on the second end surface 10b side are continuously coincident with each other. In the first U-phase coil, the relation between the start point (U1) and the end point (N) may be reversed.

As shown in FIG. 2B, the second U-phase coil is wound around the slot 12 of the stator core 10 in the same manner as the first U-phase coil. In FIG. 2B, reference numeral U2 indicates the start point of the second U-phase coil, and reference numeral N indicates the end point of the second U-phase coil. The solid-line arrow in the figure shows a state in which the second U-phase coil is displaced on the first end surface 10a side of the stator core 10, and the broken-line arrow in the figure shows a state in which the second U-phase coil is displaced on the second end surface 10b side of the stator core 10. In the second U-phase coil, the relation between the start point (U2) and the end point (N) may be reversed. Further, the end point (N) of the first coil and the start point (U2) of the second coil may be connected to each other to form a 1Y connection. Alternatively, the end point (N) of the second coil and the start point (U1) of the first coil may be connected to each other to form a 1Y connection.

The two V-phase coils and the two W-phase coils are wound around the slots 12 of the stator core 10 in the same manner as the two U-phase coils described above. That is, in the stator 2 of the present embodiment, each coil 20 has an oblique wave winding section. The winding method of the coil 20 in the oblique wave winding section (i.e., oblique wave winding) is different from the conventional lap winding and wave winding as the winding method of the coil 20. Therefore, for the purpose of suppressing resonance of the coil 20, when changing the winding method of the coil 20, in addition to the conventional lap winding and wave winding, this oblique wave winding can be added as a new option. As a result, the degree of freedom in adjusting the electrical characteristics of the stator 2 is increased, and the resonance of the coil can be suppressed more effectively.

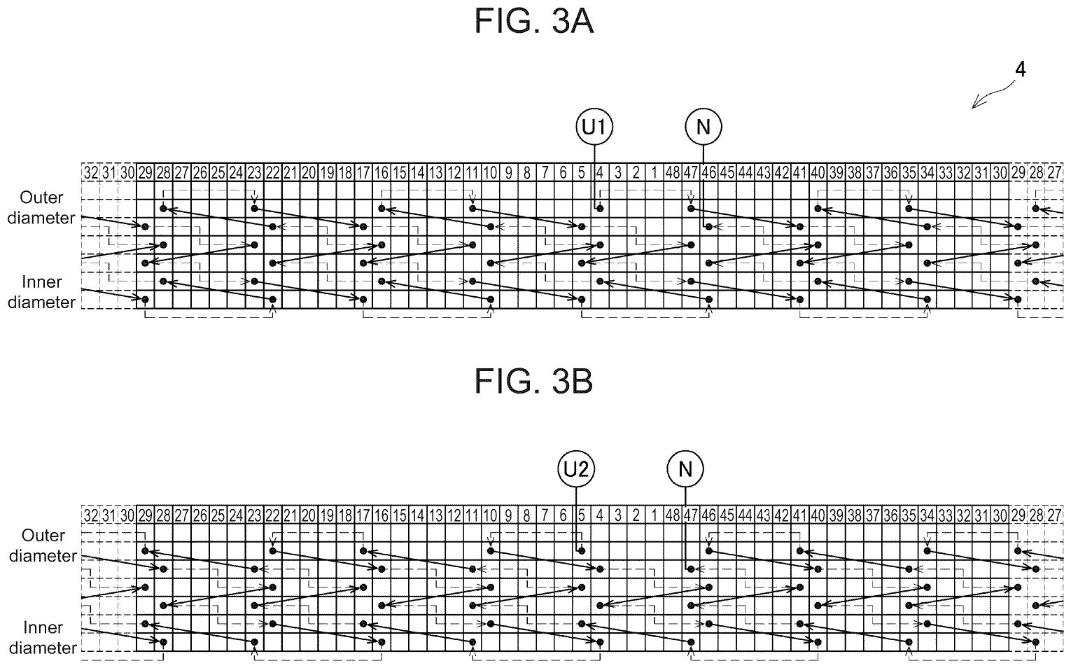

Incidentally, in the stator 2 described above, the start point (U1, U2) of the U-phase coil is located in the outermost layer, the arrangement of the U-phase coil shown in FIGS. 2A, 2B, 3A and 3B may be reversed with respect to the radial direction. That is, a start point (U1, U2) of the U-phase coil may be located in the innermost layer. This also applies to other embodiments described below.

### Second Embodiment

Referring to FIGS. 3A and 3B, a stator of the second embodiment will be described. Similar to the stator 2 of the first embodiment, the stator of the present embodiment generally has the structure shown in FIG. 1. However, in the stator of the second embodiment, the winding method of the plurality of coils 20 is changed as compared with the stator 2 of the first embodiment. The other configurations are the same as those of the stator 2 of the first embodiment, and therefore redundant description thereof will be omitted.

FIG. 3A shows the winding of the first U-phase coil of the plurality of coils 20, FIG. 3B shows the winding method of the second U-phase coil. In FIGS. 3A and 3B, the columns indicate the positions of the slots 12 in the stator core 10. The row indicates the position in the circumferential direction of the coil segment 22 in each slot 12. It should be noted that a row positioned above means that the coil segment 22 is positioned outward in the radial direction. As shown in FIGS. 3A and 3B, the inner peripheral surface of the stator core 10, 48 slots 12 are provided, in the respective slots 12, six layers of the coil segments 22 are housed.

In FIG. 3A, reference numeral U1 denotes the start point of the first U-phase coil, and reference numeral N denotes the end point of the first U-phase coil. The solid-line arrow in the figure shows a state in which the first U-phase coil is displaced on the first end surface 10a side of the stator core 10, and the broken-line arrow in the figure shows a state in which the first U-phase coil is displaced on the second end surface 10b side of the stator core 10. As shown in FIG. 3A, 1U phase coil extends from the first layer (outermost layer) start point of the fourth slot toward the second end surface 10b from the first end surface 10a of the stator core 10 in the fourth slot. The first U-phase coil shifts to the first layer of the 47th slot in the second end surface 10b side of the stator core 10, extends the 47th slot from the second end surface 10b of the stator core 10 to the first end surface 10a. Next, the first U-phase coil is displaced to the second layer of the 41st slot on the first end surface 10a of the stator core 10, and extends from the first end surface 10a of the stator core 10 toward the second end surface 10b in the 41st slot.

Thereafter, the first U-phase coil is shifted to the third layer of the 35 slots on the second end surface 10b side of the stator core 10, extends the 35 slot from the second end surface 10b of the stator core 10 to the first end surface 10a. Next, the first U-phase coil is reversely displaced toward the fourth layer of the 41st slot on the first end surface 10a of the stator core 10, and extends from the first end surface 10a of the stator core 10 toward the second end surface 10b in the 41 slot. Then, the first U-phase coil shifts again toward the fifth layer of the 35 slot in the second end surface 10b side of the stator core 10, extends the 35 slot in the second end surface 10b of the stator core 10 toward the first end surface 10a. Subsequently, the first U-phase coil is displaced to the sixth layer (innermost layer) of the 29th slot on the first end surface 10a of the stator core 10, and extends from the first end surface 10a of the stator core 10 toward the second end surface 10b in the 29 slot.

Due to the above-mentioned wind method, the first U-phase coil rolled from the first layer of the fourth slot (outermost layer) to the sixth layer of the twenty-nine slots (innermost layer) is shifted to the fifth layer of the twenty-eighth slot by reversing after it shifts to the twenty-second slot in the same sixth layer. Thereafter, the first U-phase coil is displaced in the order of the fourth layer of the 34th slot, the third layer of the 28th slot, and the second layer of the 34th slot while reversing the direction. Thereafter, the first U-phase coil is displaced to the first layer of the fortieth slot and then inverted to the thirty-fifth slot in the same first layer. Thereafter, the first U-phase coil is displaced to the second layer of the 29th slot. Hereinafter, the first U-phase coil reaches the end point located in the second layer of the forty-sixth slot by repeating the winding method in which the direction of displacement is reversed in the middle in the same manner.

As described above, in the first U-phase coil, the start point (U1) and the end point (N) are provided on the first end surface 10a of the stator core 10. In the first layer (outermost layer) and the sixth layer (innermost layer) in the radial direction in the slot 12, two coil segments 22 located in the same layer are connected to each other. Further, the section that is displaced in the radial direction between the first layer and the third layer and between the fourth layer and the sixth layer is an oblique wave winding section, and the section that is displaced in the radial direction between the third layer and the fourth layer is an overlapping winding section. In the oblique wave winding section, the direction displaced in the circumferential direction and the radial direction on the first end surface 10a side and the direction displaced in the circumferential direction and the radial direction on the second end surface 10b side are continuously coincident with each other. On the other hand, in the overlapping winding section, the direction displaced in the circumferential direction and the radial direction on the first end surface 10a side and the direction displaced in the circumferential direction and the radial direction on the second end surface 10b side are reversed and do not continuously coincide with each other.

As shown in FIG. 3B, the second U-phase coil is wound around the slot 12 of the stator core 10 in the same manner as the first U-phase coil. In FIG. 3B, reference numeral U2 indicates the start point of the second U-phase coil, and reference numeral N indicates the end point of the second U-phase coil. The solid-line arrow in the figure shows a state in which the second U-phase coil is displaced on the first end surface 10a side of the stator core 10, and the broken-line arrow in the figure shows a state in which the second U-phase coil is displaced on the second end surface 10b side of the stator core 10.

The two V-phase coils and the two W-phase coils are wound around the slots 12 of the stator core 10 in the same manner as the two U-phase coils described above. That is, in the stator 4 of the present embodiment, each of the coils 20 has an oblique wave winding section and an overlapping winding section. The winding method of the coil 20 in which the oblique wave winding and the oblique wave winding are combined is different from that of the conventional lap winding, the wave winding, and the oblique wave winding. Therefore, for the purpose of suppressing resonance of the coil 20, when changing the winding method of the coil 20, in addition to the conventional lap winding, wave winding, and oblique wave winding, the winding method in which the oblique wave winding and the lap winding are combined can be added as a new option. Accordingly, the degree of freedom in adjusting the electrical characteristics of the stator 4 is further increased, and the resonance of the coil can be suppressed more effectively.

### Modification of Second Embodiment

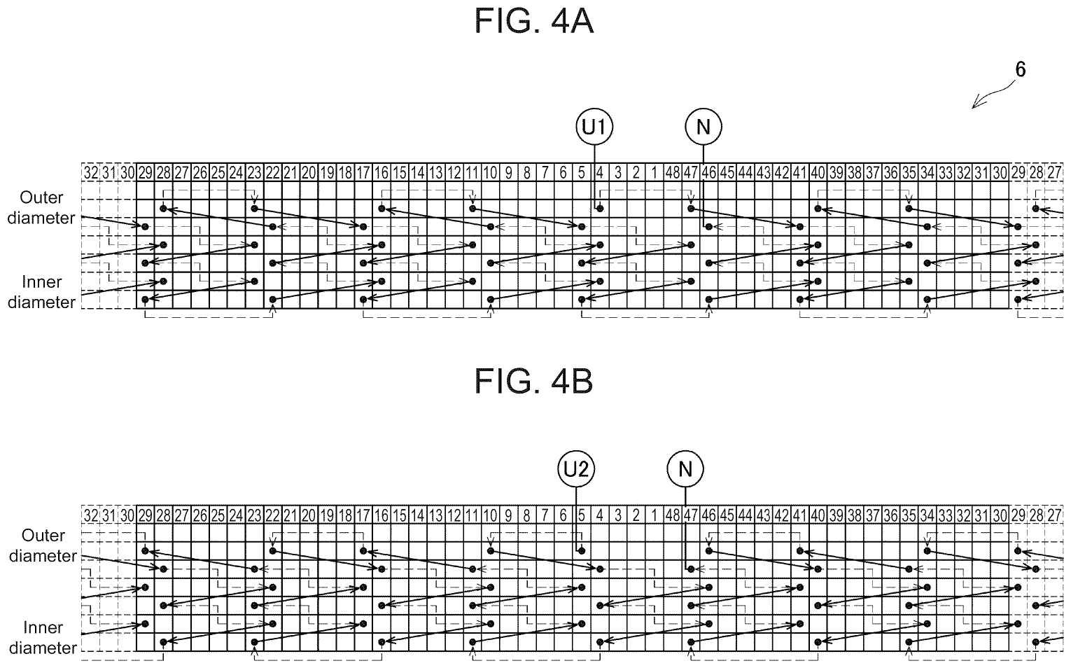

Referring to FIGS. 4A and 4B, a stator of a modification of the second embodiment will be described. Similar to the stator 4 of the second embodiment, the stator of the present embodiment generally has the structure shown in FIG. 1. However, in the stator of the modification of the second embodiment, the ratio of the section in which the plurality of coils 20 are wound in the lap winding is changed as compared with the stator 4 of the second embodiment. The other configurations are the same as those of the stator 4 of the second embodiment, and therefore redundant descriptions thereof will be omitted.

FIG. 4A shows the winding method of the first U-phase coil of the plurality of coils 20, FIG. 4B shows the winding of the second U-phase coil. In FIGS. 4A and 4B, the columns indicate the positions of the slots 12 in the stator core 10. The row indicates the circumferential direction position of the coil segment 22 in each slot 12. It should be noted that a row positioned above means that the coil segment 22 is positioned outward in the radial direction. As shown in FIGS. 4A and 4B, the inner peripheral surface of the stator core 10, 48 slots 12 are provided, in the respective slots 12, six layers of the coil segments 22 are housed.

In FIG. 4A, reference numeral U1 denotes the start point of the first U-phase coil, and reference numeral N denotes the end point of the first U-phase coil. The solid-line arrow in the figure shows a state in which the first U-phase coil is displaced on the first end surface 10a side of the stator core 10, and the broken-line arrow in the figure shows a state in which the first U-phase coil is displaced on the second end surface 10b side of the stator core 10. As shown in FIG. 4A, 1U phase coil extends from the first layer (outermost layer) start point of the fourth slot toward the second end surface 10b from the first end surface 10a of the stator core 10 in the fourth slot. The first U-phase coil shifts to the first layer of the 47th slot in the second end surface 10b side of the stator core 10, extends the 47th slot from the second end surface 10b of the stator core 10 to the first end surface 10a. Next, the first U-phase coil is displaced to the second layer of the 41st slot on the first end surface 10a of the stator core 10, and extends from the first end surface 10a of the stator core 10 toward the second end surface 10b in the 41st slot.

Thereafter, the first U-phase coil is shifted to the third layer of the 35 slots on the second end surface 10b side of the stator core 10, extends the 35 slot from the second end surface 10b of the stator core 10 to the first end surface 10a. Next, the first U-phase coil is reversely displaced toward the fourth layer of the 41st slot on the first end surface 10a of the stator core 10, and extends from the first end surface 10a of the stator core 10 toward the second end surface 10b in the 41 slot. Then, the first U-phase coil shifts again toward the fifth layer of the 35 slot in the second end surface 10b side of the stator core 10, extends the 35 slot in the second end surface 10b of the stator core 10 toward the first end surface 10a.

Subsequently, the first U-phase coil is displaced by reversing the direction to the sixth layer (innermost layer) of the 41st slot on the first end surface 10a side of the stator core 10 in the same manner as described above, and extends from the first end surface 10a of the stator core 10 toward the second end surface 10b in the 41st slot.

According to the above winding method, the first U-phase coil wound from the first layer (outermost layer) of the fourth slot to the sixth layer (innermost layer) of the forty-first slot is displaced to the thirty-fourth slot in the same sixth layer and then displaced to the fifth layer of the twenty-eighth slot. Thereafter, the first U-phase coil is displaced in the order of the fourth layer of the 34th slot, the third layer of the 28th slot, and the second layer of the 34th slot while reversing the direction. Thereafter, the first U-phase coil is displaced to the first layer of the fortieth slot and then inverted to the thirty-fifth slot in the same first layer. Thereafter, the first U-phase coil is displaced to the second layer of the 29th slot. Hereinafter, the first U-phase coil reaches the end point located in the second layer of the forty-sixth slot by repeating the winding method in which the direction of displacement is reversed in the middle in the same manner.

As described above, in the first U-phase coil, the start point (U1) and the end point (N) are provided on the first end surface 10a of the stator core 10. In the first layer (outermost layer) and the sixth layer (innermost layer) in the radial direction in the slot 12, two coil segments 22 located in the same layer are connected to each other. Further, the section that is displaced in the radial direction between the first layer and the third layer is an oblique wave winding section, and the section that is displaced in the radial direction between the third layer and the sixth layer is an overlapping winding section. In the oblique wave winding section, the direction displaced in the circumferential direction and the radial direction on the first end surface 10a side and the direction displaced in the circumferential direction and the radial direction on the second end surface 10b side are continuously coincident with each other. On the other hand, in the overlapping winding section, the direction displaced in the circumferential direction and the radial direction on the first end surface 10a side and the direction displaced in the circumferential direction and the radial direction on the second end surface 10b side are reversed and do not continuously coincide with each other.

As shown in FIG. 4B, the second U-phase coil is wound around the slot 12 of the stator core 10 in the same manner as the first U-phase coil. In FIG. 4B, reference numeral U2 indicates the start point of the second U-phase coil, and reference numeral N indicates the end point of the second U-phase coil. The solid-line arrow in the figure shows a state in which the second U-phase coil is displaced on the first end surface 10a side of the stator core 10, and the broken-line arrow in the figure shows a state in which the second U-phase coil is displaced on the second end surface 10b side of the stator core 10.

The two V-phase coils and the two W-phase coils are wound around the slots 12 of the stator core 10 in the same manner as the two U-phase coils described above. Further, the stator 6 of the present embodiment shows an example in which the ratio of each of the oblique wave winding section and the overlapping winding section in each coil 20 of the stator 4 of the second embodiment is changed. The winding method of the coil 20 such as the stator 6 is different from that of the conventional lap winding, wave winding, oblique wave winding, and stator 4, and the electrical characteristics are also different. Therefore, for the purpose of suppressing the resonance of the coil 20, when changing the winding method of the coil 20, by changing the ratio of the oblique wave winding and the lap winding in accordance with the specification, it is possible to increase the number of options. Accordingly, the degree of freedom in adjusting the electrical characteristics of the stator 6 is further increased, and the resonance of the coil can be suppressed more effectively.

### Third Embodiment

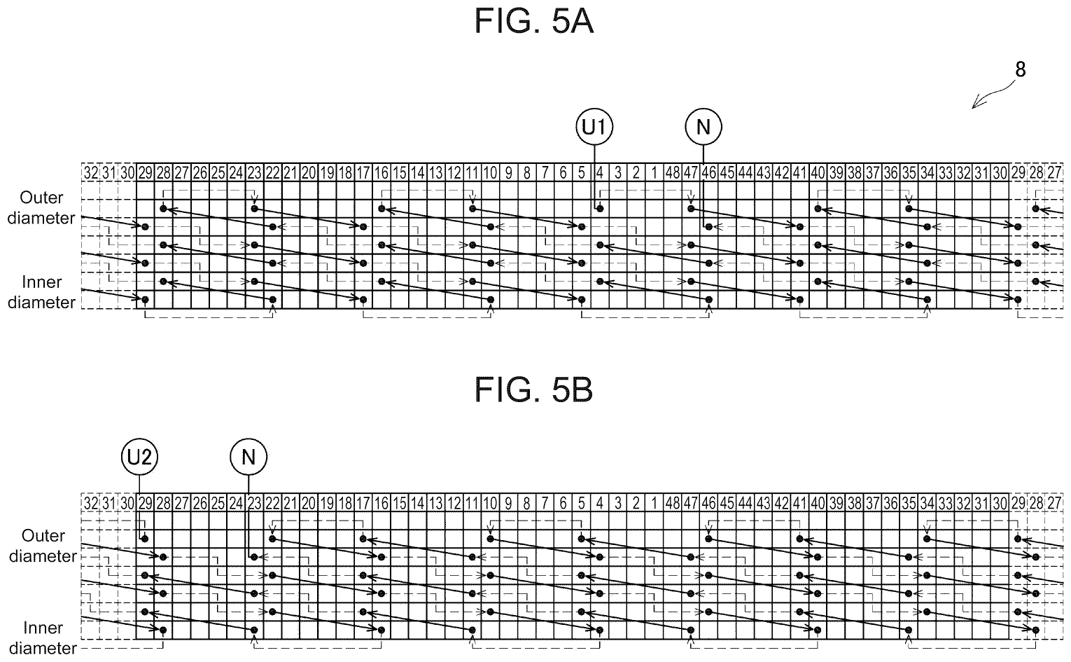

Referring to FIGS. 5A and 5B, the stator of the third embodiment will be described. Similar to the stator 2 of the first embodiment, the stator of the present embodiment generally has the structure shown in FIG. 1. However, in the stator of the third embodiment, as compared with the stator 2 of the first embodiment, the distance between the circumferential direction positions of the slots 12 at the start points U1 and U2 of the coils 20 of the respective phases is changed. The other configurations are the same as those of the stator 2 of the first embodiment, and therefore redundant description thereof will be omitted.

FIG. 5A shows the winding method of the first U-phase coil of the plurality of coils 20, FIG. 5B shows the winding of the second U-phase coil. In FIGS. 5A and 5B, the columns indicate the positions of the slots 12 in the stator core 10. The row indicates the circumferential direction position of the coil segment 22 in each slot 12. It should be noted that a row positioned above means that the coil segment 22 is positioned outward in the radial direction. As shown in FIGS. 5A and 5B, the inner peripheral surface of the stator core 10, 48 slots 12 are provided, in the respective slots 12, six layers of the coil segments 22 are housed.

In FIG. 5A, reference numeral U1 denotes the start point of the first U-phase coil, and reference numeral N denotes the end point of the first U-phase coil. The solid-line arrow in the figure shows a state in which the first U-phase coil is displaced on the first end surface 10a side of the stator core 10, and the broken-line arrow in the figure shows a state in which the first U-phase coil is displaced on the second end surface 10b side of the stator core 10. As shown in FIG. 5A, the first U phase coil is wound in the same manner as the stator 2 of the first embodiment. As shown in FIG. 5A, the first U phase coil, starting from the first layer of the fourth slot (outermost layer) start point and the second layer of the 46th slot as an end point, between the sixth layer (innermost layer) from the first layer of the slot 12 of the stator core 10 (outermost layer) is wound with oblique wave winding.

As shown in FIG. 5B, the second U-phase coil is wound around the slot 12 of the stator core 10 in the same manner as the first U-phase coil. In FIG. 5B, reference numeral U2 indicates the start point of the second U-phase coil, and reference numeral N indicates the end point of the second U-phase coil. The solid-line arrow in the figure shows a state in which the second U-phase coil is displaced on the first end surface 10a side of the stator core 10, and the broken-line arrow in the figure shows a state in which the second U-phase coil is displaced on the second end surface 10b side of the stator core 10. As shown in FIGS. 5A and 5B, the start point U1 of the first U-phase coil and the start point U2 of the second U-phase coil are wound around the slot 12 of the stator core 10 at a distance of 25 slots.

For the two V-phase coils and the two W-phase coils, similarly to the two U-phase coils described above, the start point of the first V-phase and W-phase coils and the start point of the second V-phase and W-phase coils are wound around the slot 12 of the stator core 10 at an interval of 25 slots. In the configuration of the present embodiment, the start points of the two coils of the same phase are spaced apart by a 12 q of +1 slots (q is a natural number, q=2 in the present embodiment). According to the above-described configuration, the potential difference between adjacent coils can be reduced, and the surge voltage can be further reduced. Therefore, for the purpose of suppressing the resonance of the coil 20, when changing the winding method of the coil 20, in addition to the conventional lap winding and wave winding, oblique wave winding, the start point of the coil of the same phase+1 12 q (q is a natural number) It can be added as a new option to the winding method which is spaced by a slot. Accordingly, the degree of freedom in adjusting the electrical characteristics of the stator 8 is further increased, and the resonance of the coil can be suppressed more effectively.

In the stators 2, 4, 6, and 8 of the first to third embodiments, the coil segment 22 wound around the sixth layer (innermost layer) of the slot 12 of the stator core 10 may be constituted by a litz wire. According to the above configuration, it is possible to reduce the copper vortex loss of the coils 20 of each phase. The litz wire may be adopted not only for the sixth layer of each slot 12 but also for the layer outside the sixth layer.

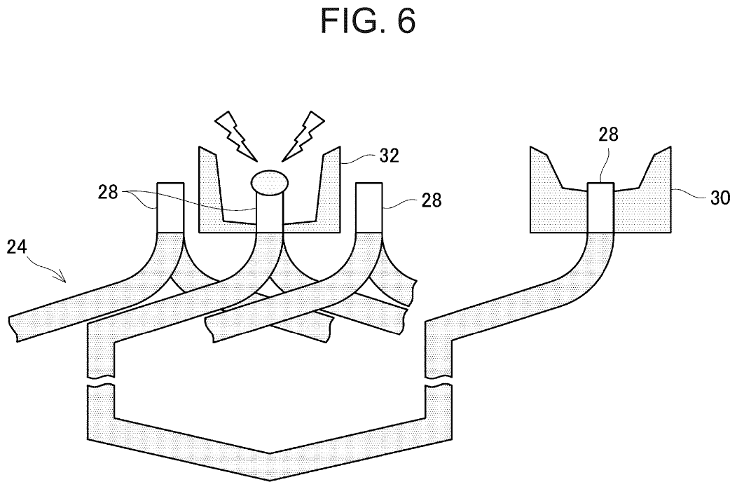

A method of joining the protrusions 24 of the coil segments 22 in the stators 2, 4, 6, and 8 of the first to third embodiments will be described with reference to FIG. 6. As shown in FIG. 6, the protrusions 24 of the coil segments 22 in the stators 2, 4, 6, 8 of the first to third embodiments are joined using TIG welds. When TIG welding a coil segment 22 having a U-shape, it is common for the joining protrusions 24 to be clamped by relatively large electrodes which also function as shielding plates. On the other hand, as shown in FIG. 6, in the coil segment 22 in the oblique wave winding section, two joints 28 located at both ends of the coil segment 22 are arranged at different positions in the circumferential direction. Therefore, in the joining method shown in FIG. 6, the clamp 32 for shielding and fixing the joint 28 located at one end and the electrode 30 for clamping the joining portion 28 located at the other end are prepared independently of each other. With such a configuration, the clamp 32 and the electrode 30 can each be miniaturized, and the length of the joint 28 of the coil segment 22 to which they are attached can also be reduced. This makes it possible to reduce the size of the stators 2, 4, 6, and 8.

Although the embodiment of the present technology has been described in detail above, the embodiment is merely an example and does not limit the scope of claims. The techniques described in the claims include various modifications and alternations of the specific examples illustrated above. The technical elements described in the present specification or the drawings exhibit technical usefulness alone or in various combinations, and are not limited to the combinations described in the claims at the time of filing. In addition, the techniques illustrated in the present specification or drawings can achieve a plurality of objectives at the same time, and achieving one of the objectives itself has technical usefulness.

What is claimed is:

1. A stator of an electric motor, the stator comprising:
a cylindrical stator core extending in an axial direction between a first end surface and a second end surface;
a plurality of slots provided on an inner peripheral surface of the stator core and arranged along a circumferential direction, each of the slots extending along the axial direction; and
a plurality of coils wound in a distributed manner on the slots, each of the coils being constituted by a plurality of coil segments, wherein
when a number of the slots is n and a number of magnetic poles of a rotor is P, a relationship of n=6 p is satisfied,
the coil segments are arranged in each of the slots such that a plurality of layers is constituted along a radial direction,
in each of the coils, a start point and an end point are provided on the first end surface side of the stator core,
in an outermost layer and an innermost layer in the radial direction within the slot, two coil segments located in a same layer are connected to each other, and
a section that is displaced in the radial direction between the outermost layer and the innermost layer includes an oblique wave winding section in which a direction of displacement in the circumferential direction and the radial direction on the first end surface side and a direction of displacement in the circumferential direction and the radial direction on the second end surface side continuously coincide with each other.

2. The stator according to claim 1, wherein in each of the coils, the section that is displaced in the radial direction between the outermost layer and the innermost layer within the slot further includes an overlapping winding section in which a direction of displacement in the circumferential direction on the first end surface side and a direction of displacement in the circumferential direction on the second end surface side are mutually inverted.

3. The stator according to claim 2, wherein:
in each of the coils, the section that is displaced in the radial direction between the outermost layer and the innermost layer further includes a wave winding section in which a direction of displacement in the circumferential direction on the first end surface side and a direction of displacement in the circumferential direction on the second end surface side continuously coincide with each other; and
the overlapping winding section is located between the oblique wave winding section and the wave winding section in the radial direction.

4. The stator according to claim 1, wherein:
the coils are 2Y or 4Y type parallel wiring; and
each start point of each coil of a same phase from among the coils is located spaced apart by 12 q +1 (q being a natural number) slots.

5. The stator according to claim 1, wherein in each of the coils, the coil segment located on the innermost layer in the radial direction within the slot is constituted by a litz wire.
